(19) United States
(12) Patent Application Publication
(10) Pub. No.: US 2012/0206152 A1
(43) Pub. Date: Aug. 16, 2012

(54) ELECTRIC LEAKAGE DETECTION APPARATUS

(75) Inventors: Hideaki Naruse, Iida-shi (JP); Satoru Miyamoto, Iida-shi (JP); Masaki Fujii, Iida-shi (JP); Kazushi Kodaira, Iida-shi (JP); Yoshihiro Ikushima, Iida-shi (JP)

(73) Assignee: Omron Automotive Electronics Co., Ltd., Komaki-shi (JP)

(21) Appl. No.: 13/398,461

(22) Filed: Feb. 16, 2012

(30) Foreign Application Priority Data
Feb. 16, 2011 (JP) 2011-030400

(51) Int. Cl. G01N 27/00

(52) U.S. Cl. 324/557

(57) ABSTRACT

An electric leakage detection apparatus may quickly detect an electric leakage. An electric leakage detection apparatus may include a pulse generator that supplies a pulse to a coupling capacitor, a voltage detector that detects a voltage at the coupling capacitor, an electric leakage determination unit that compares the voltage detected by the voltage detector with a threshold, and determines presence or absence of the electric leakage of a DC power supply based on a comparison result. The electric leakage detection apparatus may also include a discharge circuit that is operated for a constant time after the pulse falls and forcedly discharges a charge of the coupling capacitor. The pulse generator generates a new pulse when the constant time elapses.

### CROSS-REFERENCE TO RELATED APPLICATIONS

The present application claims priority from Japanese Patent Application No. 2011-030400, filed Feb. 16, 2011. The content of the priority application is hereby incorporated by reference in its entirety.

### BACKGROUND OF INVENTION

1. Technical Field

One or more embodiments of the present invention relate to an electric leakage detection apparatus that detects an electric leakage of a DC power supply.

2. Related Art

A high-voltage DC power supply is mounted on an electric automobile in order to drive a motor and an in-vehicle instrument. The DC power supply is electrically insulated from the grounded vehicle. However, when the DC power supply and a vehicle body are electrically connected for any cause, a current is passed from the DC power supply to the ground through the vehicle body to generate an electric leakage (or a ground fault). Therefore, a detection apparatus that detects the electric leakage is provided in the DC power supply. Japanese Unexamined Patent Publication No. 2003-250201 discloses a ground fault detection apparatus mounted on the electric automobile.

In the vehicle ground fault detection apparatus of Japanese Unexamined Patent Publication No. 2003-250201, a positive terminal of the DC power supply is connected onto one end side of a coupling capacitor, the coupling capacitor is charged by applying a rectangular wave pulse signal to a measuring point that constitutes the other end side of the coupling capacitor, and a voltage signal generated at the measuring point is detected to detect the ground fault of the DC power supply. A difference between a voltage measured at the measuring point at the time the rectangular wave pulse signal becomes a first phase and a voltage measured at the measuring point at the time the rectangular wave pulse signal becomes a second phase is obtained, and the ground fault of the DC power supply is detected based on the difference of the voltage.

In the ground fault detection apparatus of Japanese Unexamined Patent Publication No. 2003-250201, the discharge from the coupling capacitor is started after the charge performed to the coupling capacitor is completed, and it takes a predetermined time to end the discharge after the discharge is started. Accordingly, when a determination of presence or absence of the ground fault is made by detecting the voltage at the time a pulse falls or rises, in consideration of the discharge time of the coupling capacitor, it is necessary to wait for the ending of the discharge of the coupling capacitor after the pulse falls, and then it is necessary that the next pulse rises. Therefore, a time interval from the pulse fall to the pulse rise is lengthened to cause an issue in that it takes time to make the determination.

Japanese Unexamined Patent Publication No. 2008-89322 discloses an apparatus that detects an insulating state of the DC power supply based on the voltage at the capacitor. In this apparatus, a reset switch is provided in order to discharge the capacitor, the apparatus waits for the voltage between both ends of the capacitor to be decreased to a given voltage when the voltage between both the ends of the capacitor exceeds a maximum voltage during a normal operation, and the reset switch is turned on to rapidly charge the capacitor when the voltage between both the ends of the capacitor becomes the given voltage.

### SUMMARY OF INVENTION

One or more embodiments of the present invention has been devised to be able to quickly determine presence or absence of an electric leakage in an electric leakage detection apparatus that detects an electric leakage of a DC power supply.

According to one or more embodiments of the present invention, an electric leakage detection apparatus includes: a coupling capacitor whose one end is connected to a DC power supply; a pulse generator that supplies a pulse to the other end of the coupling capacitor; a voltage detector that detects a voltage at the coupling capacitor charged with the pulse; an electric leakage determination unit that compares the voltage detected by the voltage detector with a first threshold and determines presence or absence of an electric leakage of the DC power supply based on a comparison result; and a first discharge circuit that is operated for a constant time after the pulse falls and forcedly discharges a charge of the coupling capacitor. The pulse generator generates a new pulse when the constant time elapses.

With such a configuration, the coupling capacitor charged with the pulse is forcedly discharged through the first discharge circuit from the time the pulse falls, so that the time until the next pulse rises can be shortened to rapidly detect the electric leakage.

The electric leakage detection apparatus according to one or more embodiments of the present invention may further include a controller that controls an operation of the first discharge circuit, wherein the controller may output a control signal to the first discharge circuit when the pulse falls. In this case, the first discharge circuit may include a transistor that is put into a conduction state for the constant time based on the control signal, and may forcedly discharge the charge of the coupling capacitor through the transistor.

Moreover, the electric leakage detection apparatus according to one or more embodiments of the present invention may further include: a filter circuit that is provided between the coupling capacitor and the voltage detector; and a second discharge circuit that forcedly discharges a charge of a capacitor included in the filter circuit. In this case, the first discharge circuit and the second discharge circuit simultaneously start operations.

Moreover, in the electric leakage detection apparatus according to one or more embodiments of the present invention, the electric leakage determination unit may determine the presence or absence of the electric leakage at a predetermined time during a time interval after the pulse rises and before the voltage at the coupling capacitor is saturated.

Accordingly, the electric leakage determination unit can determine the presence or absence of the electric leakage before the coupling capacitor is saturated, and the electric leakage can quickly be detected.

Moreover, in the electric leakage detection apparatus according to one or more embodiments of the present invention, the electric leakage determination unit may determine the presence or absence of the electric leakage every time the pulse generator outputs the new pulse.

Accordingly, the number of times of the electric leakage determination can be increased to more quickly detect the electric leakage.

According to the electric leakage detection apparatus of one or more embodiments of the present invention, the coupling capacitor is forcedly discharged through the first discharge circuit, so that the time until the next pulse rises can be shortened to rapidly detect the electric leakage.

### BRIEF DESCRIPTION OF THE DRAWINGS

FIG. 1 is a circuit diagram illustrating an electric leakage detection apparatus according to one or more embodiments of the present invention;

FIG. 2 is a waveform chart of detection voltages during electric leakage and non-electric leakage according to one or more embodiments of the present invention;

FIGS. 3A-3C are timing charts describing an operation of the electric leakage detection apparatus according to one or more embodiments of the present invention; and

FIGS. 4A-4B are timing charts describing an operation of an electric leakage detection apparatus that does not includes a discharge circuit according to one or more embodiments of the present invention.

### DETAILED DESCRIPTION

In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention. Hereinafter, embodiments of the present invention will be described with reference to the drawings. The case in which one or more embodiments of the present invention is applied to an electric leakage detection apparatus mounted on an electric automobile will be described by way of example.

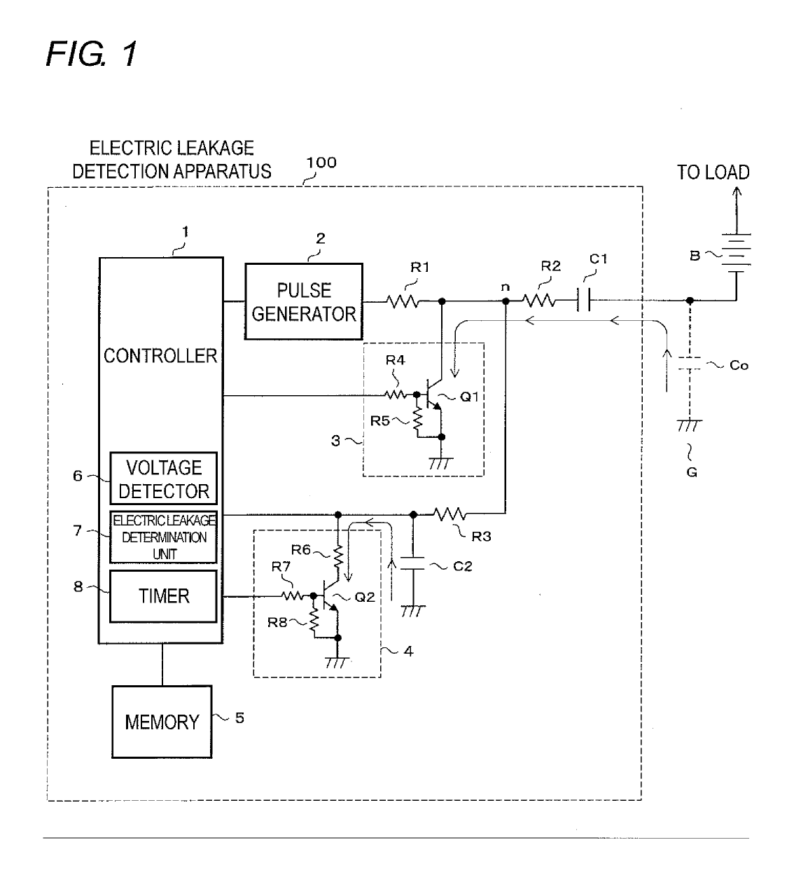

As illustrated in FIG. 1, an electric leakage detection apparatus 100 includes a controller 1, a pulse generator 2, a discharge circuit 3, a discharge circuit 4, a memory 5, resistors R1 to R3, and capacitors C1 and C2.

The controller 1 is constructed by a CPU, and the controller 1 includes a voltage detector 6, an electric leakage determination unit 7, and a timer 8. The pulse generator 2 generates a pulse having a predetermined frequency in response to an instruction from the controller 1. The resistor R1 is connected to an output side of the pulse generator 2. The resistor R2 is connected to the resistor R1 in series. A value of the resistor R2 is sufficiently lower than that of the resistor R1. One end of the capacitor C1 is connected to a negative electrode of a DC power supply B, and the other end of the capacitor C1 is connected to the resistor R2. The capacitor C1 is a coupling capacitor that separates the electric leakage detection apparatus 100 and the DC power supply B in a direct-current manner. A positive electrode of the DC power supply B is connected to a load (not illustrated). A floating capacitance Co exists between the DC power supply B and a ground G (vehicle body).

The discharge circuit 3 (first discharge circuit) includes a transistor Q1 and resistors R4 and R5. A collector of the transistor Q1 is connected to a connection point of the resistors R1 and R2. An emitter of the transistor Q1 is grounded. A base of the transistor Q1 is connected to the controller 1 through the resistor R4. The resistor R5 is connected to the base and the emitter of the transistor Q1. The discharge circuit 3 forcedly discharges charges of the coupling capacitor C1 and the floating capacitance Co through a path indicated by arrows.

One end of the resistor R3 is connected to the connection point of the resistor R1 and resistor R2. The other end of the resistor R3 is connected to the controller 1. The capacitor C2 is connected between the other end of the resistor R3 and the ground. The capacitor C2 is used as a capacitor for a filter, and the capacitor C2 and the resistor R3 constitute a filter circuit that removes a noise of a voltage input to the controller 1.

The discharge circuit 4 (second discharge circuit) includes a transistor Q2 and resistors R6 to R8. A collector of the transistor Q2 is connected to a connection point of the resistor R3 and the capacitor C2 through the resistor R6. An emitter of the transistor Q2 is grounded. A base of the transistor Q2 is connected to the controller 1 through the resistor R7. The resistor R8 is connected to the base and the emitter of the transistor Q2. The discharge circuit 4 forcedly discharges a charge of the capacitor C2 through a path indicated by arrows.

The memory 5 includes a ROM and RAM to constitute a storage. A threshold V1 described below is stored in the memory 5.

In the controller 1, the voltage detector 6 detects a voltage at the coupling capacitor C1 based on a voltage, which is taken in the controller 1 through a connection point n of the resistors R1 and R2, the resistor R3, and the capacitor C2.

The electric leakage determination unit 7 compares the voltage detected by the voltage detector 6 with the threshold V1, and determines the presence or absence of electric leakage based on a comparison result.

The timer 8 measures an elapsed time from the time a pulse output from the pulse generator 2 falls.

An operation of the electric leakage detection apparatus 100 having the above configuration will be described below.

The pulse output from the pulse generator 2 is supplied to the coupling capacitor C1 through the resistors R1 and R2. The coupling capacitor is charged with this pulse (at this time, the floating capacitance Co is also charged), and a potential at a point n rises. The potential at the point n is input to the controller 1 through the resistor R3 and the capacitor C2. The voltage detector 6 detects the voltage at the coupling capacitor C1 based on the input voltage. Hereinafter, the detected voltage is referred to as a “detection voltage”.

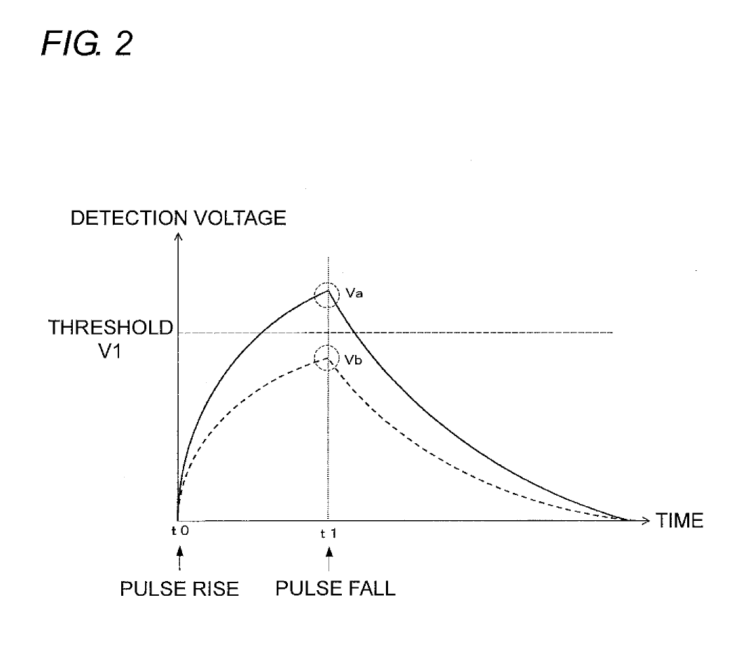

When the electric leakage from the DC power supply B to the ground G is not generated, the detection voltage steeply rises as illustrated by a solid line of FIG. 2. Therefore, the detection voltage exceeds the threshold V1 during the time interval after the pulse rises at a time t0 and before the pulse falls at a time t1. On the other hand, when the electric leakage from the DC power supply B to the ground G is generated, the detection voltage moderately rises by an influence of a time constant based on an electric leakage impedance as illustrated by a broken line of FIG. 2. Therefore, the detection voltage does not exceed the threshold V1 during the time interval from the time to t0 time t1.

The voltage detector 6 detects the voltage at the coupling capacitor C1 at the time t1 the pulse falls. The time t1 is a time which is previously set during the time interval after the pulse rises and before the voltage at the coupling capacitor C1 is saturated. The detection voltage becomes Va when the electric leakage is not generated, and the detection voltage becomes Vb when the electric leakage is generated. The electric leakage determination unit 7 compares the detection voltage with the threshold V1. When the detection voltage is not lower than the threshold V1 (Va), the electric leakage determination unit determines that the electric leakage is not generated. When the detection voltage is lower than the threshold V1 (Vb), the electric leakage determination unit determines that the electric leakage is generated.

At the time t1 where the pulse falls, the controller 1 outputs a control signal to the discharge circuits 3 and 4. The control signal puts the transistors Q1 and Q2 of the discharge circuits 3 and 4 in a conduction state, respectively. Therefore, the charges of the coupling capacitor C1 and the floating capacitance Co are discharged through the transistor Q1, and the charge of the capacitor C2 is discharged through the transistor Q2. As a result, the detection voltage is decreased after the time t1 as illustrated in FIG. 2.

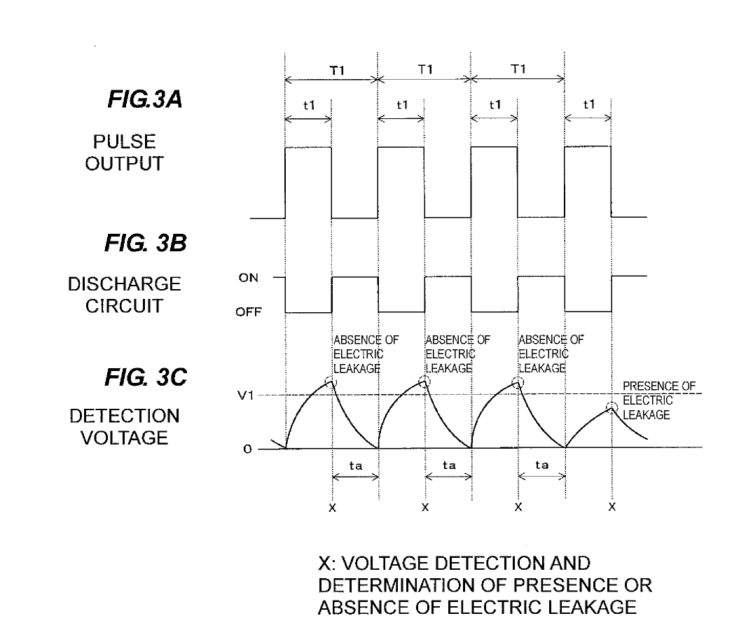

The basic operation of the electric leakage detection is as described above. The detailed operation of the electric leakage detection apparatus 100 will be described below with reference to FIGS. 3A-3C.

As illustrated in FIG. 3A, the pulse generator 2 outputs the pulse having a pulse width t1. The voltage at the coupling capacitor charged with the pulse changes as illustrated in FIG. 3C. At a pulse falling timing X, the voltage detector 6 detects the voltage at the coupling capacitor C1, and the electric leakage determination unit 7 compares the detection voltage with the threshold V1 to determine the presence or absence of the electric leakage.

At the pulse falling timing X, the controller 1 (see FIG. 1) simultaneously outputs the control signal to the discharge circuit 3 and the discharge circuit 4, and the transistors Q1 and Q2 of the discharge circuits 3 and 4 are simultaneously turned on as illustrated in FIG. 3B. That is, the discharge circuits 3 and 4 simultaneously start the operations. Therefore, as described above, the charge of the coupling capacitor C1 is discharged through the transistor Q1, and the charge of the capacitor C2 is discharged through the transistor Q2.

As illustrated in FIG. 3C, the voltage detected by the voltage detector 6 is rapidly decreased by the forced discharge from the time the coupling capacitor C1 starts the discharge. When a constant time ta measured by the timer 8 elapses, the transistors Q1 and Q2 of the discharge circuits 3 and 4 are simultaneously turned off while the next pulse rises. A value of the time ta is set to a time until the voltage at the coupling capacitor C1 becomes substantially 0 volts by the forced discharge.

As described above, in the present embodiment, the charge of the coupling capacitor C1 is forcedly discharged through the transistor Q1 of the discharge circuit 3, so that the time ta from the pulse fall to the next pulse rise can be set shorter. As a result, a pulse interval T1 in FIG. 3A can be shortened to quickly detect the electric leakage.

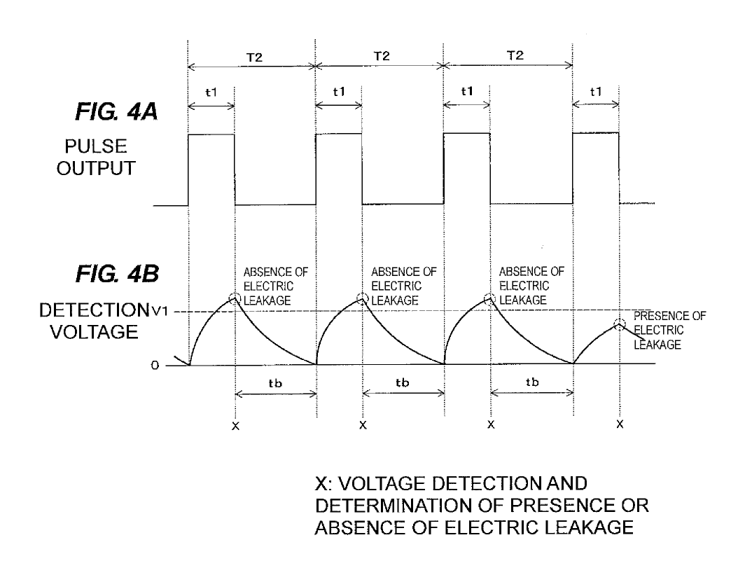

FIGS. 4A and 4B illustrate a pulse output when the discharge circuit 3 is not provided. In this case, because the voltage detected by the voltage detector 6 is not forcedly discharged, the voltage is gently decreased from the time the coupling capacitor C1 starts the discharge as illustrated in FIG. 4B. The next pulse rises when a constant time tb elapses. The time tb is longer than the time ta of FIGS. 3A-3C. Therefore, a pulse interval T2 in FIG. 4A is lengthened, and it takes a long time to detect the electric leakage.

Further, in the present embodiment, as described below, the electric leakage determination unit 7 determines the presence or absence of the electric leakage at the predetermined time (t1 in FIG. 2) during the time interval after the pulse rises and before the voltage at the coupling capacitor C1 is saturated. In the present embodiment, because the pulse rises before the voltage at the coupling capacitor C1 is saturated, the coupling capacitor C1 is not charged any more. The electric leakage determination unit 7 determines the presence or absence of the electric leakage at the time the pulse falls. Therefore, the electric leakage determination unit 7 can determine the presence or absence of the electric leakage before the coupling capacitor C1 is saturated, and the electric leakage can quickly be detected.

Moreover, in the present embodiment, as can be seen from FIGS. 3A-3C, the electric leakage determination unit 7 determines the presence or absence of the electric leakage every time the new pulse is generated from the pulse generator 2. Therefore, the number of times of the electric leakage determination can be increased to more quickly detect the electric leakage.

Various embodiments other than the embodiments described above can be employed in the present invention. In FIG. 1, the filter circuit including the resistor R3 and the capacitor C2, and the discharge circuit 4 that forcedly discharges the charge of the capacitor C2 are provided by way of example. Alternatively, the filter circuit and the discharge circuit 4 may be eliminated in one or more embodiments of the present invention.

Moreover, in the embodiment described above, at the timing the pulse output from the pulse generator 2 falls, the voltage detector 6 detects the voltage at the coupling capacitor C1, and the electric leakage determination unit 7 determines the presence or absence of the electric leakage. However, the present invention is not limited thereto. For example, at a predetermined time before the pulse falls, the voltage detector 6 may perform the voltage detection, and the electric leakage determination unit 7 may determine the presence or absence of the electric leakage.

Moreover, in the present embodiment, by way of example, the discharge circuit 3 includes the transistor Q1 and the resistors R4 and R5. Alternatively, the discharge circuit 3 may include a coil and a relay having a contact. The same holds true for the discharge circuit 4.

Further, in the embodiment described above, by way of example, the present invention is applied to the electric leakage detection apparatus mounted on the vehicle. Alternatively, the present invention may be applied to an electric leakage detection apparatus that is used in applications other than the vehicle.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. An electric leakage detection apparatus comprising:
a coupling capacitor whose one end is connected to a DC power supply;
a pulse generator that supplies a pulse to the other end of the coupling capacitor;
a voltage detector that detects a voltage at the coupling capacitor charged with the pulse;
an electric leakage determination unit that compares the voltage detected by the voltage detector with a first threshold, and determines presence or absence of an electric leakage of the DC power supply based on a comparison result; and
a first discharge circuit that is operated for a constant time after the pulse falls and forcedly discharges a charge of the coupling capacitor, wherein
the pulse generator generates a new pulse when the constant time elapses.

2. The electric leakage detection apparatus according to claim 1, further comprising a controller that controls an operation of the first discharge circuit, wherein
the controller outputs a control signal to the first discharge circuit when the pulse falls,
the first discharge circuit includes a transistor that is put into a conduction state for the constant time based on the control signal, and forcedly discharges the charge of the coupling capacitor through the transistor.

3. The electric leakage detection apparatus according to claim 1, further comprising:
a filter circuit that is provided between the coupling capacitor and the voltage detector; and
a second discharge circuit that forcedly discharges a charge of a capacitor included in the filter circuit, wherein
the first discharge circuit and the second discharge circuit simultaneously start operations.

4. The electric leakage detection apparatus according to claim 1, wherein the electric leakage determination unit determines the presence or absence of the electric leakage at a predetermined time during a time interval after the pulse rises and before the voltage at the coupling capacitor is saturated.

5. The electric leakage detection apparatus according to claim 1, wherein the electric leakage determination unit determines the presence or absence of the electric leakage every time the pulse generator outputs the new pulse.
